(19) United States
(12) Patent Application Publication
(10) Pub. No.: US 2026/0134458 A1
(43) Pub. Date: May 14, 2026

(54) TECHNIQUES FOR PAYMENT TERM OPTIMIZATION

(71) Applicant: SAP SE, Walldorf (DE)

(72) Inventors: Gregor Berg, Berlin (DE); Andreas Breitrueck, Oftersheim (DE); Stephan Baier, Oberrieden (CH); Alexander Cramer, Berlin (DE)

(21) Appl. No.: 18/944,906

(22) Filed: Nov. 12, 2024

(51) Int. Cl. G06Q 30/04; G06Q 20/10; G06Q 40/03

(52) U.S. Cl. CPC G06Q 30/04; G06Q 20/102; G06Q 40/03

(57) ABSTRACT

In some implementations, techniques may include accessing stored payment data. For each payment term of a plurality of payment terms, the techniques may include calculating a distribution of payment dates before, on, and after a due date. The techniques may include determining the effectiveness of each of a plurality of payment terms based in part on the distribution of payment dates, where effectiveness is defined as a time difference between a payment due date and a payment date. The techniques may include determining a recommended payment term based at least in part on the effectiveness of each of the plurality of payment terms and an objective. The techniques may include generating an invoice including the recommended payment term.

### BACKGROUND

Companies across many different industries and geographies send out invoices to customers in order to get paid for the goods and services provided. The invoices provide details of the amount owed, the due date for payment, and the terms and conditions for how the invoice should be paid.

Historical information regarding payment terms and conditions, any discounts offered for early payment can be stored in a company's enterprise resource planning (ERP) system. For example, the terms and conditions can specify a specific number of days that a customer has to pay without a penalty (e.g., 10, 30, 60, or 90 days). A company may offer optional discounts to customers for early payments (e.g., a discount of 3% if the invoice is paid at least five days early.)

A company then must manage hundreds of payment terms for various different customers. In addition to a company's standard terms and conditions, certain customers may request special conditions (e.g., a small/medium supplier being strong-armed into unfavorable terms by its main customer.). Companies have difficulty in tracking how many of the hundreds of payment terms are actually used (e.g., usually less than 20% of the payment terms are used). Companies also have difficulty in determining how often active payment terms are used. Further, companies have difficulty tracking how successful the different payment terms are. For example, if customers are asked to pay within a predetermined time (e.g., 28 days) and the customers pay after 32 days, that payment plan would be considered unsuccessful. However, if customers are asked to pay within 30 days, on average, and the customers pay after 31 days, the second plan would also be unsuccessful but may be a better option than the 28-day term.

Customers have difficulty in determining how a specific payment term is adhered to on the invoiced amount, the geography and the length or volume of the customer relationship, or in some cases certain customers may explicitly wait until the first dunning before paying if the supplier is not the preferred customer. Dunning is the process of methodically communicating with customers to ensure the collection of accounts receivable. Communications progress from gentle reminders to threatening letters and phone calls and more or less intimidating location visits as accounts become more overdue.

Companies desire a holistic view across their cash flow to determine how to best manage payment terms and collections to recover payments that they are owed in a timely manner.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, computer implemented methods may include accessing stored payment data. In various embodiments, the stored payment data may include historic sales data and pending sales transactions. For each payment term of a plurality of payment terms, the method can include calculating a distribution of payment dates before, on, and after a due date. The method may include determining an effectiveness of each of a plurality of payment terms based in part on the distribution of payment dates, where effectiveness is defined as a time difference between a payment due date and a payment date. The method may include determining a recommended payment term based at least in part on the effectiveness of each of the plurality of payment terms and an objective. This method may also include generating an invoice for the particular customer including the recommended payment term. Other embodiments of this aspect include corresponding computer systems, apparatus, and computer programs recorded on one or more computer storage devices, each configured to perform the actions of the methods. Implementations may include one or more of the following features. In various embodiments, the objective is to minimize a days sales outstanding value. In various embodiments, the objective is to maximize revenue. In various embodiments, the stored payment data includes customer country information. The computer implemented method may include comparing the effectiveness of each of the plurality of payment terms for each of a plurality of countries for various countries and determining the recommended payment term based in part on the comparing the effectiveness of each of the plurality of payment terms for each of the plurality of countries for various countries. In various embodiments, the stored payment data includes customer segment information. The computer implemented method may include comparing the effectiveness of each of the plurality of payment terms for each of a plurality of customer segments. In various embodiments, the determining the recommended payment term is further based in part on comparing the effectiveness of each of the plurality of payment terms for each of a plurality of customer segments. In various embodiments, the stored payment data includes customer country information and customer segment information. The computer implemented method may include comparing the effectiveness of each of the plurality of payment terms for each of a plurality of customer segments within a specific country. In various embodiments, the determining the recommended payment term is further based in part on the comparing the effectiveness of each of the plurality of payment terms for each of a plurality of customer segments within the specific country. The computer implemented method where the recommended payment term is further based in part on historic sales data for the particular customer.

The computer implemented method may include determining a plurality of payment terms. The method may include displaying the plurality of payment terms. The method may include receiving a selection of one of the pluralities of the payment terms. In various embodiments, the generating the invoice including the selected payment term as the recommended payment term. The computer implemented method may include generating a customer ranking based in part on the length of relationship and a volume of transactions; and determining a recommended payment term based in least in part on the customer ranking.

Implementation of the described techniques may be performed by a system including various hardware components, as a method or process, or stored as a series of instructions on a computer-readable tangible medium.

The following detailed description and accompanying drawings provide a better understanding of the nature and advantages of various embodiments of the present disclosure.

### BRIEF DESCRIPTION OF THE DRAWINGS

FIG. 1 illustrates a process flow for a customer transaction.

FIG. 2 illustrates a first table listing percentage of cash discount payments as a function of the value of the invoice.

FIG. 3 illustrates a second table listing percentage of cash discount payments as a function of the number of cash discount days.

FIG. 4 illustrates an extract of payment data.

FIG. 5 illustrates an exemplary graph of discount efficiency versus time for a payment term.

FIG. 6 illustrates an exemplary embodiment of the disclosed techniques for optimizing payment terms.

FIG. 7 illustrates a second graph of the percentage of received payments over time by plotting the percentage of received payments according to the days since the invoices were posted.

FIG. 8 is a flowchart of an example process for optimizing payment terms.

FIG. 9 illustrates an exemplary computer system for implementing various embodiments described above.

FIG. 10 illustrates an exemplary computing device for implementing various embodiments described above.

FIG. 11 illustrates an exemplary system for implementing various embodiments described above.

### DETAILED DESCRIPTION

In the following description, for purposes of explanation, numerous examples and specific details are set forth to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for optimizing a payment play for customer invoices. In various aspects, the system can intake historical data and recommend payment terms for a customer invoice for goods or services. The recommended payment terms can be reviewed by a user at the company generating the invoice in order to ensure that the recommendations match the company's objectives.

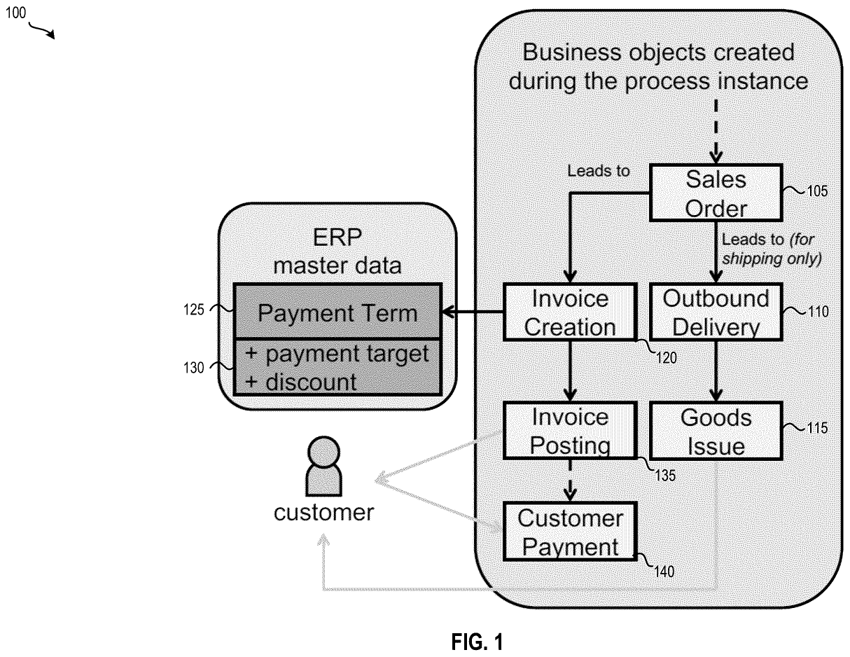

FIG. 1 illustrates a domain model and process flow 100 for a customer transaction (e.g., order-to-cash). In various embodiments, a customer orders a good or service and a sales order 105 is created. For the purposes of disclosure, it does not matter how the order is placed (e.g., in-person, on-line, phone, facsimile, electronic mail, etc.). The techniques can be applied for any time of transaction in which a company is owed payment for goods or services.

In the case of a sales order 105 for goods, the item(s) can be planned to be shipped to the customer thereby creating an outbound delivery 110 for the customer. When the item(s) leave(s) the storage or manufacturing facility (e.g., warehouse) a goods issue 115 is marked in the system.

Around the same time, an invoice 120 is created to be sent to the customer. The invoice 120 can be transmitted to the customer may any one of various means (e.g., electronically (email, text message, facsimile) or via postal service. The disclosed techniques can be the same regardless of invoice delivery means. The invoice 120 can be based on one payment term 125 definition as part of an Enterprise Resource Planning (ERP) master data. An Enterprise Resource Planning (ERP) system can be an integrated software platform used by organizations to manage and streamline their business processes across various departments. The ERP centralizes data and processes related to finance, human resources, supply chain, manufacturing, sales, and other key functions, enabling better coordination and decision-making. Exemplary ERPs can include but are not limited to SAP ERP, Oracle ERP Cloud, Microsoft Dynamics 365, NetSuite ERP, and Infor CloudSuite.

The payment term 125 can inform the customer of the amount owed, including payment currency, and how many days the customer has to pay the invoice 120 (i.e., payment target). In various embodiments, the invoice 120 can include a payment target discount 130 that can be applied for early payments. After the invoice 120 is created it can be posted 135 for view by the customer.

Ideally, the customer performs a customer payment 140 for the invoice 120 within the payment target timeframe and the invoice amount is matched with the payment. The match can also be made using the invoice reference numbers that the customers can include with their payment description. Even without invoice reference numbers, the invoice 120 can be cleared if the expected payment of the invoiced customer can be found in the many payments that can be received each day.

In case the customers do not pay the invoiced amount within the payment target date, the company can initiate a dunning process for these customers. Dunning is a structured process aimed at recovering owed funds from customers who have not paid for goods or services provided by a business. Factors influencing the dunning process include the amount of debt, customer relationships, and the length of overdue payments. Businesses must adhere to legal constraints during dunning to avoid legal consequences and maintain their reputation.

Companies would like to improve cash flow by increasing timely payments from customers, which would reduce the time and efforts required for dunning. One way to achieve improved cash flow is by having customers pay invoices early even if it results in a discounted amount.

In various embodiments, one way to improve timely payments by customers is to vary the payment terms based on several factors. These factors can include customer geography, customer market, payment discounts, and customer historical payments (cleared payments).

Payment data can be stored in an ERP system. The payment data can be analyzed to determine which payment terms in the master payment data are used, how often the payment terms are used, and what trends are over time regarding the payment dates for various payment terms including discounts if offered.

The master data can be analyzed to determine how successful different payment terms are for specific clients, for customer geographies, and for customer sectors.

Customers in certain geographic areas may pay later due to a variety of factors influenced by regional economic, cultural, and business factors to include economic conditions, cultural norms, business practices and terms, and logistical and administrative delays. In areas with economic challenges, customers may have less disposable income and may delay payments until they have sufficient funds. Limited access to banking services or credit facilities can impact on a customer's ability to make timely payments. Some regions have cultural norms where delayed payments are more acceptable or common. In certain business cultures, extended payment terms might be considered a norm or even a sign of good business relations. In some industries, longer payment terms are standard practice. This can vary significantly depending on region and industry. Businesses in certain areas might be accustomed to negotiating longer payment terms, often as a result of regional business practices. In areas dealing with international transactions, currency exchange and compliance with local regulations can lead to delays. Bureaucratic delays or slower administrative processes in certain regions can cause delays in payment processing. Long-standing business relationships may allow customers more leniency in payment schedules. Certain geographic areas may experience seasonal economic fluctuations, affecting customers'cash flow and payment timings. In some regions, limited access to modern banking and payment systems can cause delays. In areas with less developed infrastructure, customers may experience difficulties in communication or accessing necessary resources to process payments. Understanding these factors can help businesses develop strategies to manage and mitigate delayed payments, such as offering flexible payment options, strengthening relationships, or adjusting credit terms based on regional insights.

Some customers choose to pay later when the customers are satisfied with the rate of return on investment of funds that would be used for payment. Therefore, a small discount rate for early payment would not necessarily influence early payment. If a company has this knowledge about customer preferences it would allow for more customized payment terms between the parties.

Success with regard to payment terms can be measured by determining how often customers pay on time or within the payment target date deadlines clustered by the number of payments or total of payments received. Analysis of the master payment data can determine whether discounts (e.g., a 2% discount for paying 5 days before the due date) lead to customers paying invoices earlier or not.

The master payment data can be filtered to drill down to better understand variations in payments based on different payment terms. For example, the payment data can be filtered by customer to determine which payment terms are most successful for a given customer. The payment data can inform a company which payment terms are the most successful resulting in a customer paying in a positive manner.

The payment data can be ranked to illustrate the length and the volume of a commercial relationship between a customer and the company. This can also be extended to parent companies or subsidiary companies. This ranking can be done in total or on a periodic basis (e.g., yearly).

The filter options can help companies understand which payment terms work in combination with discount terms based on which country the customer is based in.

The analysis can be used to provide recommendations on payment terms dynamically for different invoices/customer context and based on company goals (e.g., cash flow).

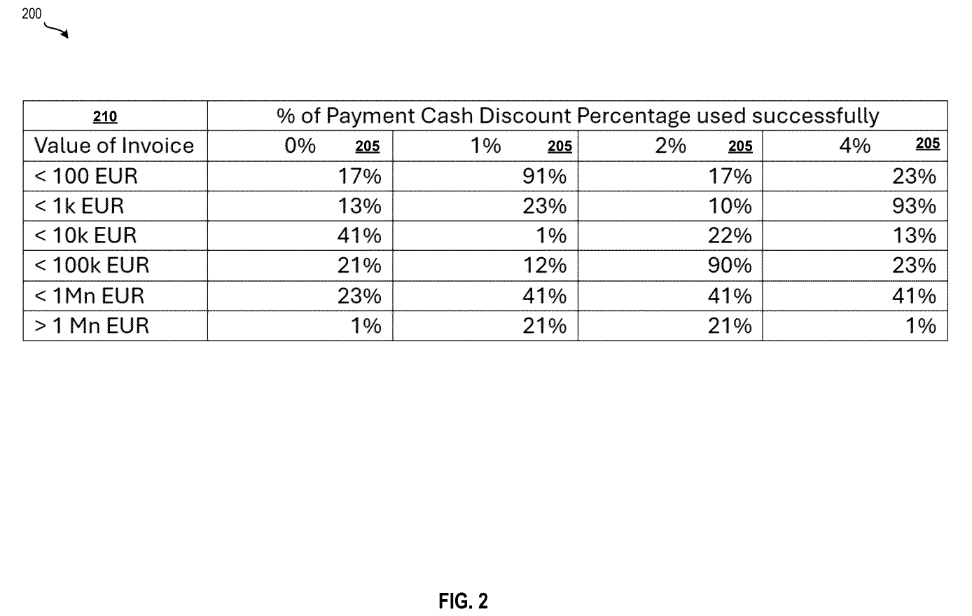

FIG. 2 illustrates a first table 200 listing percentage of cash discount payments as a function of the value of the invoice. For example, various discount terms 205 can be applied (e.g., 0%, 1%, 2%, 4%, etc.). For example, a 1% discount would offer the customer a 1% discount on the invoiced value if the payment is made within a predetermined number of days of the payment date (e.g., 5 days early). While the first table 200 lists four different payment discount terms, any number of discount terms can be applied and are in no way limited to the values provided in the first table 200.

In one non-limiting example, the first table 200 lists a 91% success rate for a 1% discount rate for invoices less than 100 Euros. The system can analyze the stored payment and discount data and discount rates that result in high percentages of early payments for each of the values of the invoice. The system can also determine discount rates with low success rates. While the first table 200 lists six distinct values (e.g., <100 EUR, <1 k EUR, <10 k EUR, <100 k EUR, <1 million EUR, and >1 million EUR), any number of values of invoices can be used in the analysis. In another example, providing no discount (e.g., a discount rate of 0%) for invoice amounts under 10,000 EUR results at a 41% success rate. This discount rate may be the optimal return for invoice amounts less than 10,000 EUR because all other success rates are lower for the same invoice range.

Companies look for ways to increase liquidity. When the payment data can be mined to determine ways to increase liquidity even small discount rates, companies can use this knowledge to improve liquidity when done on scale.

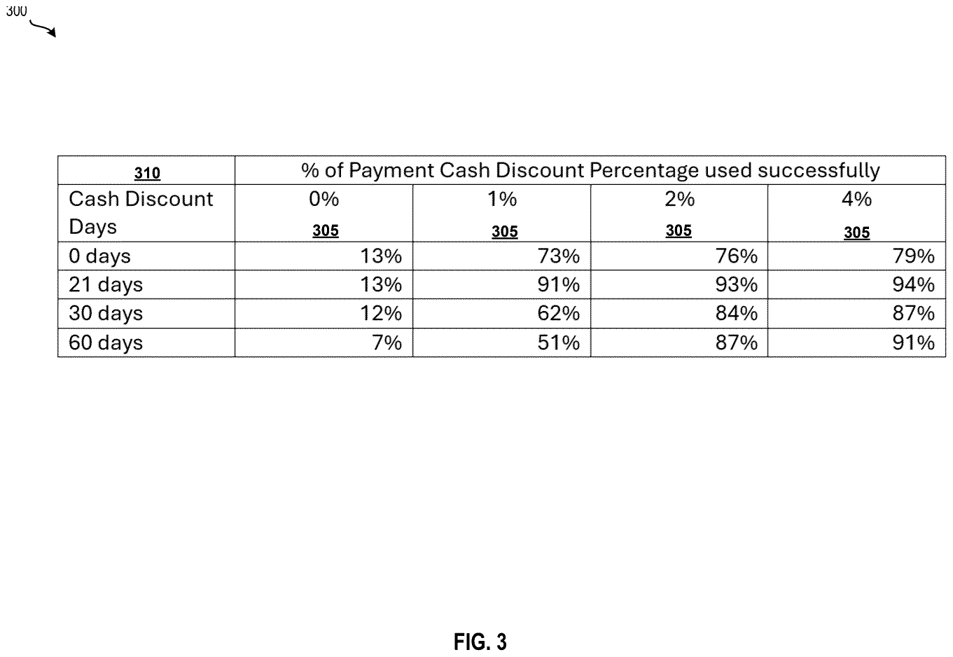

FIG. 3 illustrates a second table 300 listing the percentage of cash discount payments as a function of the number of cash discount days. For example, various discount terms 305 can be applied (e.g., 0%, 1%, 2%, 4%, etc.). For example, a 1% discount would offer the customer a 1% discount on the invoiced value if the payment is made within a predetermined number of days of the payment date (e.g., 21 days early). While the second table 300 lists four different payment terms, any number of discount terms can be applied and are in no way limited to the values provided in the second table 300.

In one non-limiting example, the second table 300 lists a 91% success rate for a 1% discount rate for payments 21 days early. The system can analyze the stored payment and discount data and discount rates that result in high percentages of early payments for each of the values of the invoice. The system can also determine discount rates with low success rates. While the second table 300 lists four distinct values for cash discount days 310 (e.g., 0 days, 21 days, 30 days and 60), any number of discount days 310 can be used in the analysis.

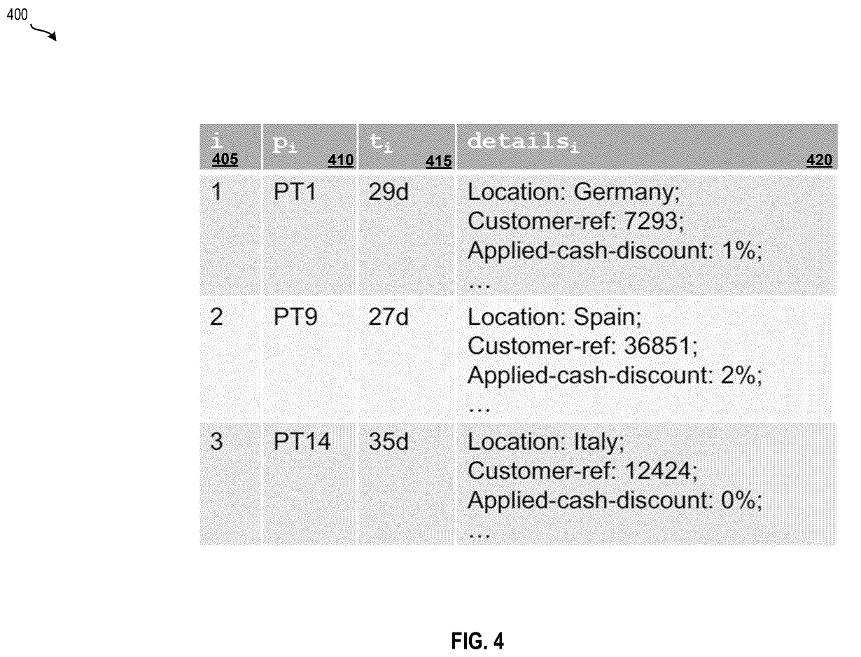

FIG. 4 illustrates an extract 400 of payment data. The extract 400 contains sale transaction number (i) 405, a payment term (pᵢ) 410, a time passed (tᵢ) 415 that measures the days between when invoice was created and when invoice was cleared, and details 420 of the transaction. The details 420 can include customer location (e.g., country, city, state, province), a customer reference number, products and/services purchased, and a discount rate. The master customer data can be viewed using commercial data extraction tools (e.g., SAP Signavio Process Insights).

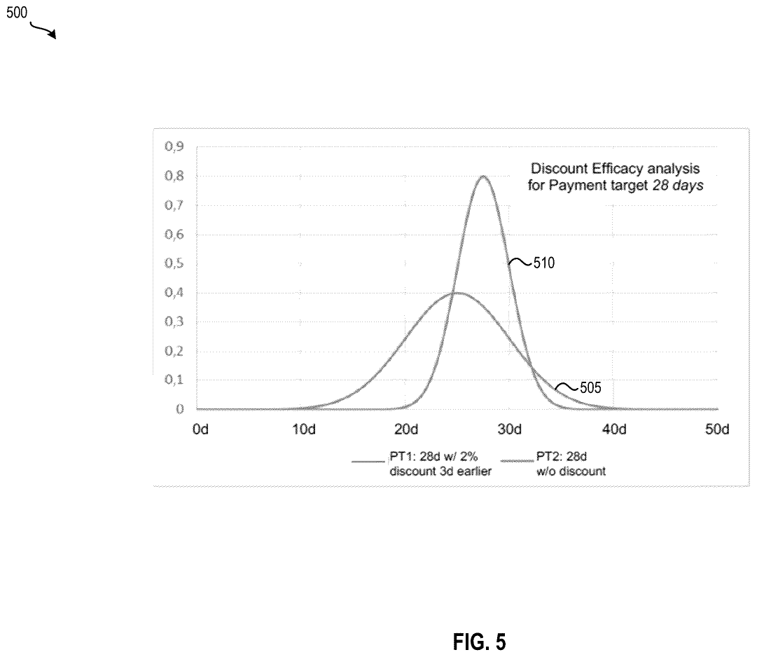

FIG. 5 illustrates an exemplary graph 500 of discount efficiency versus time for a payment term. A first line 505 indicates a distribution of payment dates for a first payment term in which the payment date is 28 days with a 2% discount if paid three days early. A second line 510 indicates a second payment term in which the payment date is 28 days without any discount for early payment. As shown in FIG. 5, the peak distribution of payments for the first line 505 appears to be 24 days with the majority of payments made prior to the deadline of 28 days. This can be compared to the peak of payments for the second line 510 in which the peak of payments is around the 28-day mark.

From the first line 505 and the second line 510, the effectiveness of each of the payment types can be determined. The effectiveness is the distribution of payments around the due date. In various embodiments, there can be drill-down options for various different factors (e.g., the value of invoices affected). The disclosed techniques can also determine the effectiveness of the same payment term in different countries, different products or services, or any attribute that can be extracted from the data. The disclosed techniques can analyze the impacts of a discount on the customer's willingness to pay early or just on time based on the amount of money at issue or the count of orders. The disclosed techniques can compare payment terms to determine which is more efficient in specific scenarios (e.g., specific countries and customer segments).

In various embodiments, the payment behavior for specific customer segments (e.g., automotive industry in Germany) can be performed to inform a supplier company about the best-in-class days sales outstanding (DSO). For example, if a customer is trying to obtain extended payment terms (e.g., 90 days or 120 days) but the industry standard is way less (e.g., 60 days) the techniques can provide information to the company to refuse such extended payment terms if the standards in the industry are much less. This provides transparency in the market that may be currently lacking.

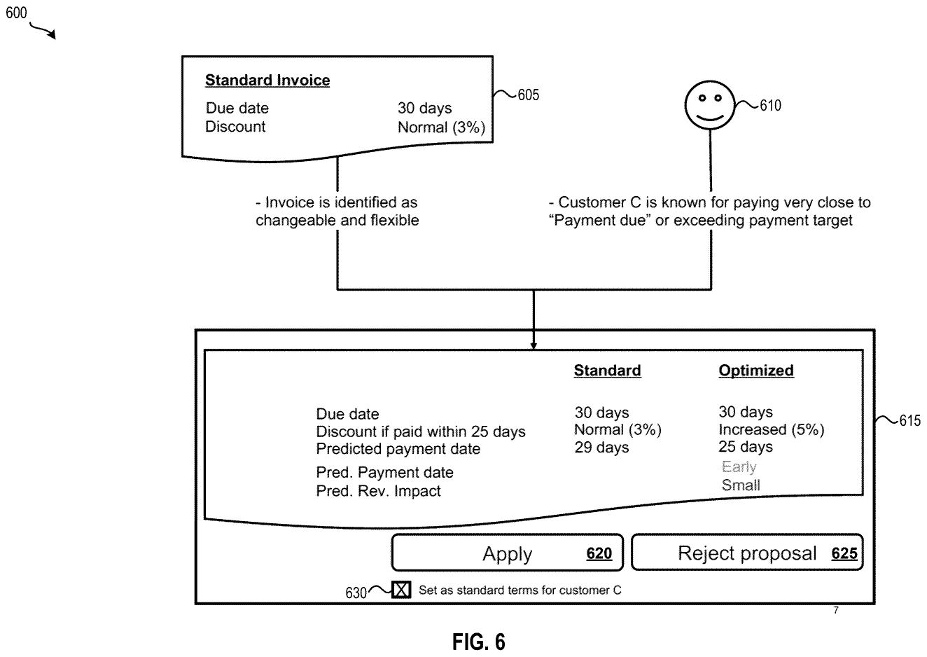

FIG. 6 illustrates an exemplary embodiment of the disclosed techniques. In various embodiments, a standard invoice 605 can include a due date of 30 days and a discount of 3% if paid early. This invoice can be identified as changeable and flexible. Customer C 610 can be known for paying very close to the payment due date or exceeding payment target based at least in part on the historical payment data.

The disclosed techniques can automatically recommend optimized terms during the customer's billing cycle. For each invoice that is generated, the disclosed techniques can recommend the most beneficial payment terms for the company, based at least in part on the customer, the product, and the payment history. The disclosed techniques can thus optimize the invoice to achieve the maximum revenue versus the lowest DSO for different products, countries, and customer segments. Additionally, presets can be created to ensure a consistent application of the best option.

FIG. 6 illustrates a graphical user interface (GUI) 615 that allows a user to review the optimized terms for an invoice. In various embodiments, GUI 615 can present the standard terms and the optimized terms. For example, the optimized terms can change the discount. The disclosed techniques can calculate the probability that this change in discount may result in an earlier payment date. The disclosed techniques can also predict the impact on overall revenue. The GUI 615 can receive an input from a user whether to accept the optimized terms by selecting the Apply button 620 or to reject the optimized terms by selecting the Reject Proposal button 625. Additionally, the GUI 615 can include a checkbox 630 that would allow the user to set the optimized terms as the standard terms for the selected customer, in this case Customer C.

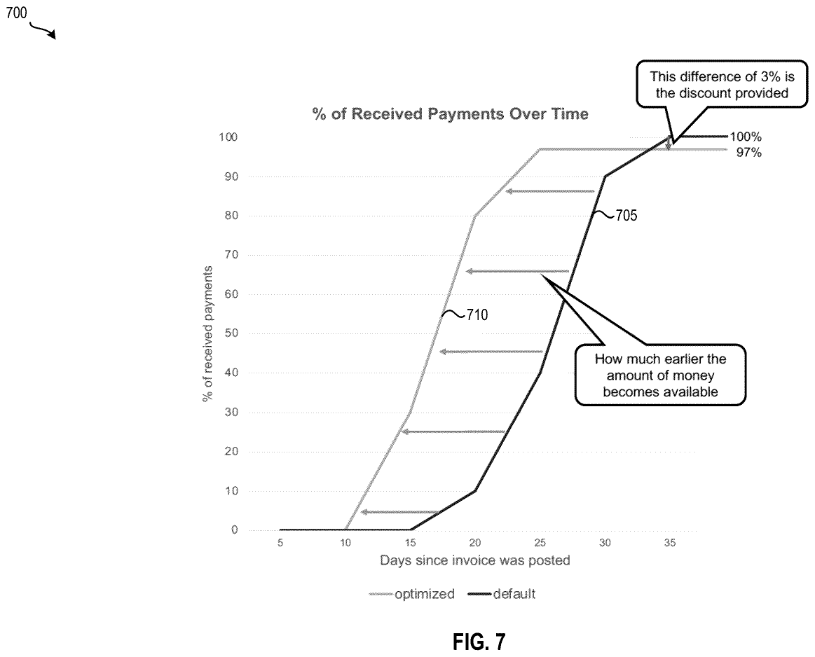

FIG. 7 illustrates a second graph 700 of the percentage of payments received over time by plotting the percentage of payments received according to the days since the invoices were posted. The first payment line 705 illustrated the default payment schedule using the standard terms. Ideally the first payment line 705 will result in 100% of all payments being received after a period of time. A second payment line 710 illustrates an optimized payment schedule with a discount applied (e.g., 3%). As shown in FIG. 7, the top of the second payment line 710 ends at 97% because of the discount. However, the rate of invoices being paid will be faster due to the discount for early payment resulting in increased cash flow. As the proposed changes are applied at scale, the overall financial performance of a company with respect to accounts receivable can be optimized leading to an increased cash flow for further use. By applying these optimization techniques, companies can have an improved likelihood of receiving the funds owed earlier allowing for greater use of working capital to invest in the next improvement projects.

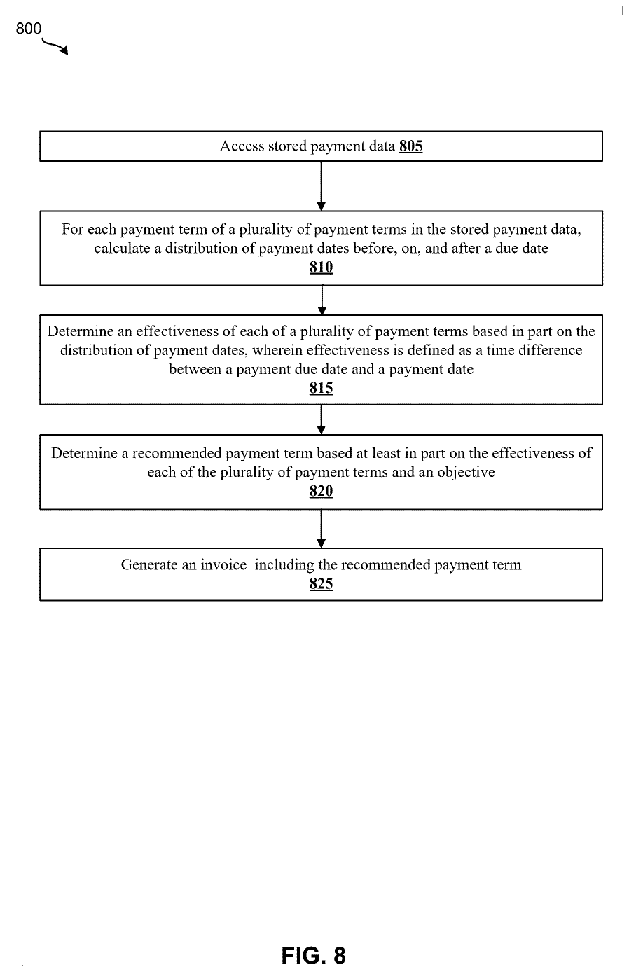

FIG. 8 is a flowchart of an example process 800. In some implementations, one or more process blocks of FIG. 8 may be performed by a computing device.

At block 805, process 800 may include accessing stored payment data. In various embodiments, the stored payment data can include historic sales data and pending sales transactions. For example, computing devices may access stored payment data, as described above. In various embodiments the payment data may be stored on a cloud-based system. In various embodiments the payment data may be accessed through a network, e.g., the Internet.

In various embodiments, the stored payment data may include a payment term, a payment time, a customer country for the sales transaction, a customer segment, and one or more discounts applied to a customer. A payment term may include a payment due date, an amount due, and any discount that may be applied for any early payment. The payment time can be the date the payment was received by the company. A customer segment can be a broad consumer or business market into sub-groups based on shared characteristics. Some exemplary customer segments can include but are not limited to automotive, aerospace, medical devices, pharmaceuticals, etc.

At block 810, process 800 may include for each payment term of a plurality of payment terms, calculating a distribution of payment dates before, on, and after a due date. For example, a computing device may for each payment term of a plurality of payment terms, calculate a distribution of payment dates before, on, and after a due date, as described above.

At block 815, process 800 may include determining an effectiveness of each of a plurality of payment terms based in part on the distribution of payment dates, where effectiveness is defined as a time difference between a payment due date and a payment date. For example, computing device may determine an effectiveness of each of the plurality of payment terms based in part on the distribution of payment dates, where effectiveness is defined as a time difference between a payment due date and a payment date, as described above.

At block 820, process 800 may include determining a recommended payment term based at least in part on the effectiveness of each of the plurality of payment terms and an objective. For example, computing device may determine a recommended payment term based at least in part on the effectiveness of each of the plurality of payment terms and an objective, as described above. In various embodiments, machine learning techniques may be applied to analyze the stored payment data and determine the recommended payment terms. The objective can be a business objective. In various embodiments, the objective can be selected by a user (e.g., by a company). In various embodiments, the objective can be to minimize a days sales outstanding value. In various embodiments, the objective can be to maximize revenue.

Given a set of payment term variables, the process distinguishes between changeable and non-changeable terms. An organization can further define a set of target variables, like revenue, profit, and liquidity. Given a set of historical customer data, the techniques can use correlation analysis to identify general impact and strength of impact of all changeable terms onto target variables for the whole population and subsets of the population (industry, region, account volume, etc.).

The techniques can further identify second level impacts like seasons or macro-economic effects (interest rate changes etc.). Once an order is received, the system can analyze the current conditions and characteristics of the customer, obtain the current settings of the target variables of the organization, and create an optimal set of payment terms as the recommended payment term for the given situation and target.

Analyzing stored payment data to recommend future payment terms involves leveraging various data analysis and machine learning techniques.

Descriptive analytics can be used to recommend payment terms. One technique uses data profiling to understand the distribution and characteristics of payment data, such as average payment amounts, frequency, delays, and variances.

Another technique uses segmentation of the data to categorize customers based on payment behaviors, such as early payers, late payers, or those who pay on time.

Trend analysis can be performed to identify historical trends, such as seasonal changes in payment behaviors or the impact of specific external factors (e.g., economic changes).

Predictive Analytics can also be applied to predict customer behavior.

In various embodiments regression analysis can be performed to predict future payment behavior based on historical data. For instance, linear or logistic regression can be used to estimate the likelihood of late payments.

In various embodiments classification models can be used that use machine learning algorithms like decision trees, random forests, or support vector machines to classify customers into different risk categories.

In other embodiments, Time Series Forecasting can use models like ARIMA or LSTM (Long Short-Term Memory networks) to forecast future payment amounts or delays.

Prescriptive Analytics can be used to calculate recommended payment terms from analysis of the stored payment data.

In various embodiments, optimization models can be used to formulate and solve optimization problems to recommend the best payment terms based on the trade-off between risk and reward.

In various embodiments, modeling and simulation techniques can be employed using Monte Carlo simulations to model different payment term scenarios and assess the impact on cash flow and risk.

In various embodiments behavioral analysis can be used to calculate recommended payment terms from analysis of the stored payment data.

In various embodiments, Customer Lifetime Value (CLV) techniques can calculate the CLV to determine the most valuable customers and align payment terms with their value.

In various embodiments, churn prediction can predict the likelihood of customer churn and adjust payment terms to improve retention.

Risk Analysis can be used to calculate recommended payment terms from analysis of the stored payment data.

In various embodiments, credit scoring models can implement scoring systems to assess the creditworthiness of customers and recommend payment terms based on risk levels.

In various embodiments, anomaly detection can use clustering or neural network models to detect unusual payment patterns that may indicate risk or fraud.

Feature Engineering and Enrichment can be used to calculate recommended payment terms from analysis of the stored payment data.

In various embodiments, payment behavior techniques can create features such as average payment delay, variance in payment amounts, and frequency of payments to feed into predictive models.

In various embodiments, external data integration can incorporate external data such as industry benchmarks, economic indicators, or credit scores to enhance the accuracy of predictions. For example, if in a certain country no companies are able to get terms better than 60 days it may not be worth efforts to reduce those payment terms below 60 days.

Data Visualization and Reporting techniques can be used to calculate recommended payment terms from analysis of the stored payment data.

In various embodiments, dashboard creation can develop interactive dashboards to visualize payment trends and metrics.

In various embodiments, scorecards and reports can generate scorecards or summary reports for stakeholders with recommended payment terms and their justification.

Natural Language Processing (NLP) can be used to calculate recommended payment terms from analysis of the stored payment data.

In various embodiments, text analysis techniques can be used to analyze textual data from customer communications, emails, or notes to extract insights about payment intentions or disputes.

In various embodiments, sentiment analysis techniques can use sentiment analysis on customer feedback to identify potential payment issues.

Clustering and Segmentation can be used to calculate recommended payment terms from analysis of the stored payment data.

In various embodiments, K-Means clustering can be used to group customers with similar payment behaviors for more targeted recommendations.

In various embodiments, hierarchical clustering can create a hierarchical representation of customer segments based on payment characteristics.

By combining these techniques, the system can recommend payment terms that align with the risk profiles and historical behaviors of customers, ultimately improving cash flow and reducing bad debt.

In various embodiments, the stored payment data includes customer country information and process 800 further includes comparing the effectiveness of each of the plurality of payment terms for each of a plurality of countries for various countries. In various embodiments, the determining the recommended payment term is further based in part on the comparing the effectiveness of each of the plurality of payment terms for each of the plurality of countries for various countries.

In various embodiments, the stored payment data includes customer segment data and process 800 further includes comparing the effectiveness of each of the plurality of payment terms for each of a plurality of customer segments. In various embodiments, the determining the recommended payment term is further based in part on the comparing the effectiveness of each of the plurality of payment terms for each of a plurality of customer segments.

In various embodiments, the stored payment data includes customer country information and customer segment data. Process 800 further includes comparing the effectiveness of each of the plurality of payment terms for each of a plurality of customer segments within a specific country. In various embodiments, the determining the recommended payment term is further based in part on the comparing the effectiveness of each of the plurality of payment terms for each of a plurality of customer segments within the specific country.

In various embodiments, the recommended payment term is further based in part on historic sales data for the particular customer.

In various embodiments, process 800 further includes generating a customer ranking based in part on the length of relationship and a volume of transactions; and determining a recommended payment term based in least in part on the customer ranking.

At block 825, process 800 may include generating an invoice including the recommended payment term. For example, a computing device may generate an invoice including the recommended payment term, as described above. In various embodiments, the invoice may be for a particular customer or for a particular type of invoice e.g., invoices for particular goods, invoices for customers in particular jurisdictions, or invoices for particular industries. The invoice can be generated electronically or by hardcopy.

Process 800 may include additional implementations, such as any single implementation or any combination of implementations described below and/or in connection with one or more other processes described elsewhere herein.

In various embodiments, process 800 further includes determining a plurality of payment terms. Process 800 may include displaying the plurality of payment terms. Process 800 may include receiving a selection of one of the pluralities of the payment terms. In various embodiments, the generating the invoice includes the selected payment term as the recommended payment term.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

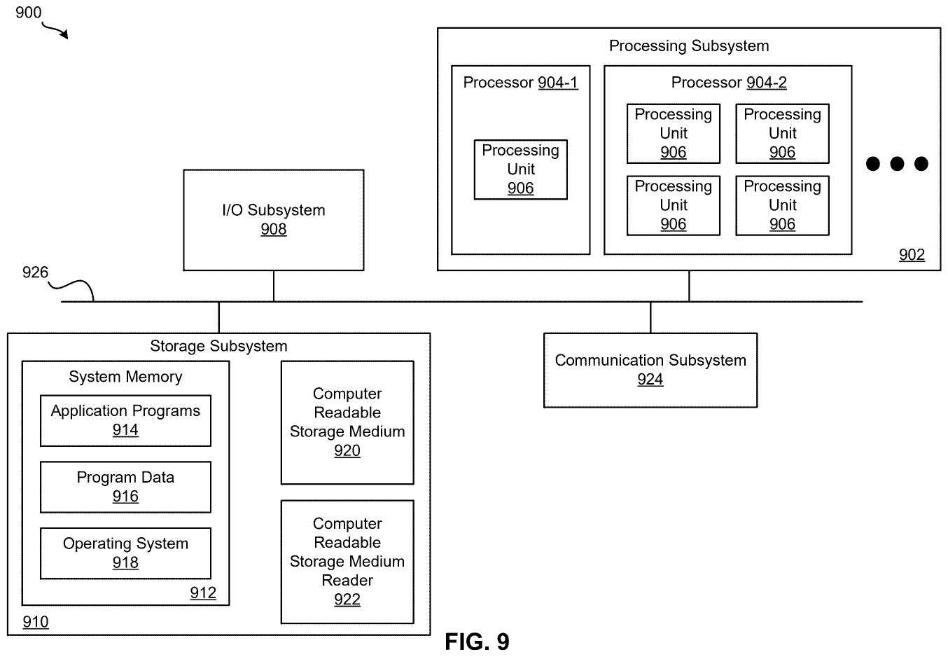

FIG. 9 illustrates an exemplary computer system 900 for implementing various embodiments described above. Computer system 900 may be a desktop computer, a laptop, a server computer, or any other type of computer system or combination thereof. In addition, computer system 900 can implement many of the operations, methods, and/or processes described above (e.g., process 800). As shown in FIG. 9, computer system 900 includes processing subsystem 902, which communicates, via bus subsystem 926, with input/output (I/O) subsystem 908, storage subsystem 910 and communication subsystem 924.

Bus subsystem 926 is configured to facilitate communication among the various components and subsystems of computer system 900. While bus subsystem 926 is illustrated in FIG. 9 as a single bus, one of ordinary skill in the art will understand that bus subsystem 926 may be implemented as multiple buses. Bus subsystem 926 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 902, which can be implemented as one or more integrated circuits (e.g., a conventional microprocessor or microcontroller), controls the operation of computer system 900. Processing subsystem 902 may include one or more processors 904. Each processor 904 may include one processing unit 906 (e.g., a single core processor such as processor 904-1) or several processing units 906 (e.g., a multicore processor such as processor 904-2). In some embodiments, processors 904 of processing subsystem 902 may be implemented as independent processors while, in other embodiments, processors 904 of processing subsystem 902 may be implemented as multiple processors integrate into a single chip or multiple chips. Still, in some embodiments, processors 904 of processing subsystem 902 may be implemented as a combination of independent processors and multiple processors integrated into a single chip or multiple chips.

In some embodiments, processing subsystem 902 can execute a variety of programs or processes in response to program code and can maintain multiple concurrently executing programs or processes. At any given time, some or all of the program code to be executed can reside in processing subsystem 902 and/or in storage subsystem 910. Through suitable programming, processing subsystem 902 can provide various functionalities, such as the functionalities described above by reference to process 800.

I/O subsystem 908 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 900 to a user or another device (e.g., a printer).

As illustrated in FIG. 9, storage subsystem 910 includes system memory 912, computer-readable storage medium 920, and computer-readable storage medium reader 922. System memory 912 may be configured to store software in the form of program instructions that are loadable and executable by processing subsystem 902 as well as data generated during the execution of program instructions. In some embodiments, system memory 912 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 912 may include different types of memory, such as static random-access memory (SRAM) and/or dynamic random-access memory (DRAM). System memory 912 may include a basic input/output system (BIOS), in some embodiments, which is configured to store basic routines to facilitate transferring information between elements within computer system 900 (e.g., during start-up). Such a BIOS may be stored in ROM (e.g., a ROM chip), flash memory, or any other type of memory that may be configured to store the BIOS.

As shown in FIG. 9, system memory 912 includes application programs 914, program data 916, and operating system (OS) 918. OS 918 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 920 may be a non-transitory computer-readable medium configured to store software (e.g., programs, code modules, data constructs, instructions, etc.). Many of the components and/or processes (e.g., process 800) described above may be implemented as software that when executed by a processor or processing unit (e.g., a processor or processing unit of processing subsystem 902) perform the operations of such components and/or processes. Storage subsystem 910 may also store data used for, or generated during, the execution of the software.

Storage subsystem 910 may also include computer-readable storage medium reader 922 that is configured to communicate with computer-readable storage medium 920. Together and optionally, in combination with system memory 912, computer-readable storage medium 920 may comprehensively represent remote, local, fixed, and/or removable storage devices plus storage media for temporarily and/or more permanently containing, storing, transmitting, and retrieving computer-readable information.

Computer-readable storage medium 920 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 924 serves as an interface for receiving data from, and transmitting data to other devices, computer systems, and networks. For example, communication subsystem 924 may allow computer system 900 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 924 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 924 may provide components configured for wired communication (e.g., Ethernet) in addition to or instead of components configured for wireless communication.

One of ordinary skill in the art will realize that the architecture shown in FIG. 9 is only an example architecture of computer system 900, and that computer system 900 may have additional or fewer components than shown, or a different configuration of components. The various components shown in FIG. 9 may be implemented in hardware, software, firmware, or any combination thereof, including one or more signal processing and/or application specific integrated circuits.

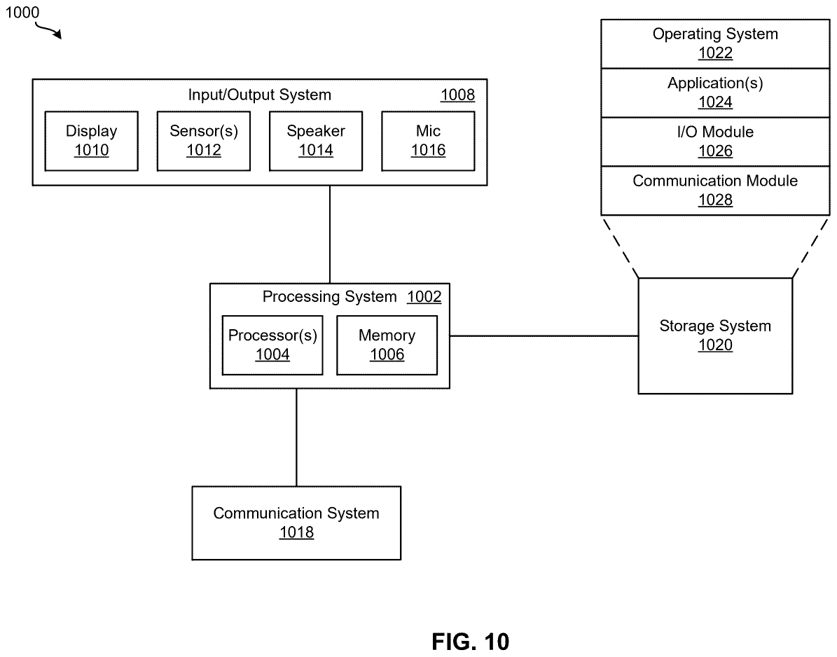

FIG. 10 illustrates an exemplary computing device 1000 for implementing various embodiments described above. Computing device 1000 may be a cellphone, a smartphone, a wearable device, an activity tracker or manager, a tablet, a personal digital assistant (PDA), a media player, or any other type of mobile computing device or combination thereof. In addition, computing device 1000 can implement many of the operations, methods, and/or processes described above (e.g., process 800). As shown in FIG. 10, computing device 1000 includes processing system 1002, input/output (I/O) system 1008, communication system 1018, and storage system 1020. These components may be coupled by one or more communication buses or signal lines.

Processing system 1002, which can be implemented as one or more integrated circuits (e.g., a conventional microprocessor or microcontroller), controls the operation of computing device 1000. As shown, processing system 1002 includes one or more processors 1004 and memory 1006. Processors 1004 are configured to run or execute various software and/or sets of instructions stored in memory 1006 to perform various functions for computing device 1000 and to process data.

Each processor of processors 1004 may include one processing unit (e.g., a single core processor) or several processing units (e.g., a multicore processor). In some embodiments, processors 1004 of processing system 1002 may be implemented as independent processors while, in other embodiments, processors 1004 of processing system 1002 may be implemented as multiple processors integrated into a single chip. Still, in some embodiments, processors 1004 of processing system 1002 may be implemented as a combination of independent processors and multiple processors integrated into a single chip.

Memory 1006 may be configured to receive and store software (e.g., operating system 1022, applications 1024, I/O module 1026, communication module 1028, etc. from storage system 1020) in the form of program instructions that are loadable and executable by processors 1004 as well as data generated during the execution of program instructions. In some embodiments, memory 1006 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 1008 is responsible for receiving input through various components and providing output through various components. As shown for this example, I/O system 1008 includes display 1010, one or more sensors 1012, speaker 1014, and microphone 1016. Display 1010 is configured to output visual information (e.g., a graphical user interface (GUI) generated and/or rendered by processors 1004). In some embodiments, display 1010 is a touch screen that is configured to also receive touch-based input. Display 1010 may be implemented using liquid crystal display (LCD) technology, light-emitting diode (LED) technology, organic LED (OLED) technology, organic electro luminescence (OEL) technology, or any other type of display technologies. Sensors 1012 may include any number of different types of sensors for measuring a physical quantity (e.g., temperature, force, pressure, acceleration, orientation, light, radiation, etc.). Speaker 1014 is configured to output audio information and microphone 1016 is configured to receive audio input. One of ordinary skill in the art will appreciate that I/O system 1008 may include any number of additional, fewer, and/or different components. For instance, I/O system 1008 may include a keypad or keyboard for receiving input, a port for transmitting data, receiving data and/or power, and/or communicating with another device or component, an image capture component for capturing photos and/or videos, etc.

Communication system 1018 serves as an interface for receiving data from, and transmitting data to, other devices, computer systems, and networks. For example, communication system 1018 may allow computing device 1000 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 1018 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 1018 may provide components configured for wired communication (e.g., Ethernet) in addition to or instead of components configured for wireless communication.

Storage system 1020 handles the storage and management of data for computing device 1000. Storage system 1020 may be implemented by one or more non-transitory machine-readable mediums that are configured to store software (e.g., programs, code modules, data constructs, instructions, etc.) and store data used for, or generated during, the execution of the software. Many of the components and/or processes (e.g., process 800) described above may be implemented as software that when executed by a processor or processing unit (e.g., processors 1004 of processing system 1002) performs the operations of such components and/or processes.

In this example, storage system 1020 includes operating system 1022, one or more applications 1024, I/O module 1026, and communication module 1028. Operating system 1022 includes various procedures, sets of instructions, software components and/or drivers for controlling and managing general system tasks (e.g., memory management, storage device control, power management, etc.) and facilitates communication between various hardware and software components. Operating system 1022 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 1024 can include any number of different applications installed on computing device 1000. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 1026 manages information received via input components (e.g., display 1010, sensors 1012, and microphone 1016) and information to be outputted via output components (e.g., display 1010 and speaker 1014). Communication module 1028 facilitates communication with other devices via communication system 1018 and includes various software components for handling data received from communication system 1018.

One of ordinary skill in the art will realize that the architecture shown in FIG. 10 is only an example architecture of computing device 1000, and that computing device 1000 may have additional or fewer components than shown, or a different configuration of components. The various components shown in FIG. 10 may be implemented in hardware, software, firmware, or any combination thereof, including one or more signal processing and/or application specific integrated circuits.

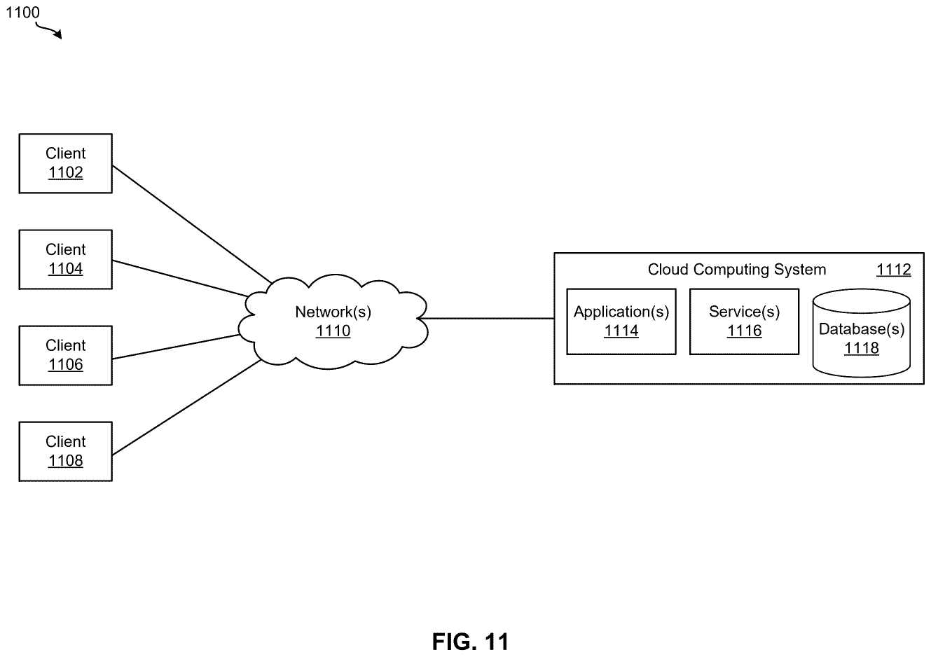

FIG. 11 illustrates an exemplary system 1100 for implementing various embodiments described above. For example, any client devices 1102-1108 may be used to implement the cloud computing system 1112. As shown, system 1100 includes client devices 1102-1108, one or more networks 1110, and cloud computing system 1112. Cloud computing system 1112 is configured to provide resources and data to client devices 1102-1108 via networks 1110. In some embodiments, cloud computing system 1112 provides resources to any number of different users (e.g., customers, tenants, organizations, etc.). Cloud computing system 1112 may be implemented by one or more computer systems (e.g., servers), virtual machines operating on a computer system, or a combination thereof.

As shown, cloud computing system 1112 includes one or more applications 1114, one or more services 1116, and one or more databases 1118. Cloud computing system 1112 may provide applications 1114, services 1116, and databases 1118 to any number of different customers in a self-service, subscription-based, elastically scalable, reliable, highly available, and secure manner.

In some embodiments, cloud computing system 1112 may be adapted to automatically provision, manage, and track a customer's subscriptions to services offered by cloud computing system 1112. Cloud computing system 1112 may provide cloud services via different deployment models. For example, cloud services may be provided under a public cloud model in which cloud computing system 1112 is owned by an organization selling cloud services and the cloud services are made available to the general public or different industry enterprises. As another example, cloud services may be provided under a private cloud model in which cloud computing system 1112 is operated solely for a single organization and may provide cloud services for one or more entities within the organization. The cloud services may also be provided under a community cloud model in which cloud computing system 1112 and the cloud services provided by cloud computing system 1112 are shared by several organizations in a related community. The cloud services may also be provided under a hybrid cloud model, which is a combination of two or more of the aforementioned different models.

In some instances, any one of applications 1114, services 1116, and databases 1118 made available to client devices 1102-1108 via networks 1110 from cloud computing system 1112 is referred to as a “cloud service.” Typically, servers and systems that make up cloud computing system 1112 are different from the on-premises servers and systems of a customer. For example, cloud computing system 1112 may host an application and a user of one of client devices 1102-1108 may order and use the application via networks 1110.

Applications 1114 may include software applications that are configured to execute on cloud computing system 1112 (e.g., a computer system or a virtual machine operating on a computer system) and be accessed, controlled, managed, etc. via client devices 1102-1108. In some embodiments, applications 1114 may include server applications and/or mid-tier applications (e.g., HTTP (hypertext transfer protocol) server applications, FTP (file transfer protocol) server applications, CGI (common gateway interface) server applications, JAVA server applications, etc.). Services 1116 are software components, modules, applications, etc. that are configured to execute on cloud computing system 1112 and provide functionalities to client devices 1102-1108 via networks 1110. Services 1116 may be web-based services or on-demand cloud services.

Databases 1118 are configured to store and/or manage data that is accessed by applications 1114, services 1116, and/or client devices 1102-1108. For instance, the customer sales data may be stored in databases 1118. Databases 1118 may reside on a non-transitory storage medium local to (and/or resident in) cloud computing system 1112, in a storage-area network (SAN), on a non-transitory storage medium local located remotely from cloud computing system 1112. In some embodiments, databases 1118 may include relational databases that are managed by a relational database management system (RDBMS). Databases 1118 may be a column-oriented databases, row-oriented databases, or a combination thereof. In some embodiments, some or all of databases 1118 are in-memory databases. That is, in some such embodiments, data for databases 1118 are stored and managed in memory (e.g., random access memory (RAM)).

Client devices 1102-1108 are configured to execute and operate a client application (e.g., a web browser, a proprietary client application, etc.) that communicates with applications 1114, services 1116, and/or databases 1118 via networks 1110. This way, client devices 1102-1108 may access the various functionalities provided by applications 1114, services 1116, and databases 1118 while applications 1114, services 1116, and databases 1118 are operating (e.g., hosted) on cloud computing system 1112. Client devices 1102-1108 may be computer system 600 or computing device 1000, as described above by reference to FIGS. 6 and 10, respectively. Although system 1100 is shown with four client devices, any number of client devices may be supported.

Networks 1110 may be any type of network configured to facilitate data communications among client devices 1102-1108 and cloud computing system 1112 using any of a variety of network protocols. Networks 1110 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments and are presented to illustrate the flexibility and advantages of various embodiments of the present disclosure as defined by the following claims. Based on the above disclosure and the following claims, other arrangements, embodiments, implementations, and equivalents will be evident to those skilled in the art and may be employed without departing from the spirit and scope of the present disclosure as defined by the claims.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or” unless explicitly stated otherwise (e.g., if used in combination with “either” or “only one of”).

What is claimed is:

1. A computer implemented method comprising:
accessing stored payment data;
for each payment term of a plurality of payment terms in the stored payment data, calculating a distribution of payment dates before, on, and after a due date;
determining an effectiveness of each of a plurality of payment terms based in part on the distribution of payment dates, wherein effectiveness is defined as a time difference between a payment due date and a payment date;
determining a recommended payment term based at least in part on the effectiveness of each of the plurality of payment terms and an objective; and
generating an invoice including the recommended payment term.

2. The computer implemented method of claim 1, wherein the objective is to minimize a days sales outstanding value.

3. The computer implemented method of claim 1, wherein the objective is to maximize revenue.

4. The computer implemented method of claim 1, wherein the stored payment data includes customer country information, the computer implemented method further comprising:
comparing the effectiveness of each of the plurality of payment terms for each of a plurality of countries for various countries; and
wherein the determining the recommended payment term is further based in part on the comparing the effectiveness of each of the plurality of payment terms for each of the plurality of countries for various countries.

5. The computer implemented method of claim 1, wherein the stored payment data includes customer segment data, the computer implemented method further comprising:
comparing the effectiveness of each of the plurality of payment terms for each of a plurality of customer segments; and
wherein the determining the recommended payment term is further based in part on the comparing the effectiveness of each of the plurality of payment terms for each of a plurality of customer segments.

6. The computer implemented method of claim 1, further comprising:
determining a plurality of payment terms
displaying the plurality of payment terms;
receiving a selection of one of the plurality of the payment terms; and
wherein the generating the invoice includes the selected payment term as the recommended payment term.

7. The computer implemented method of claim 1, further comprising:
generating a customer ranking based in part on a length of relationship and a volume of transactions; and
wherein the determining the recommended payment term is further based in least in part on the customer ranking.

8. A non-transitory computer-readable medium storing a set of instructions, the set of instructions when executed by one or more processors of a device, cause the device to perform operations comprising:
access stored payment data;
for each payment term of a plurality of payment terms in the stored payment data, calculate a distribution of payment dates before, on, and after a due date;
determine an effectiveness of each of a plurality of payment terms based in part on the distribution of payment dates, wherein effectiveness is defined as pa time difference between a payment due date and a payment date;
determine a recommended payment term based at least in part on the effectiveness of each of the plurality of payment terms and an objective; and
generate an invoice including the recommended payment term.

9. The non-transitory computer-readable medium of claim 8, wherein the objective is to minimize a days sales outstanding value.

10. The non-transitory computer-readable medium of claim 8, wherein the objective is to maximize revenue.

11. The non-transitory computer-readable medium of claim 8, wherein the stored payment data includes customer country information, the operations further comprise:
comparing the effectiveness of each of the plurality of payment terms for each of a plurality of countries for various countries; and
wherein the determining the recommended payment term is further based in part on the comparing the effectiveness of each of the plurality of payment terms for each of the plurality of countries for various countries.

12. The non-transitory computer-readable medium of claim 8, wherein the stored payment data includes customer segment data, the operations further comprise:
comparing the effectiveness of each of the plurality of payment terms for each of a plurality of customer segments; and
determining the recommended payment term based in part on the comparing the effectiveness of each of the plurality of payment terms for each of a plurality of customer segments.

13. The non-transitory computer-readable medium of claim 8, wherein the one or more instructions that, when executed by the one or more processors of the device, cause the device to perform operations comprising:
determining a plurality of payment terms;
displaying the plurality of payment terms;
receiving a selection of one of the plurality of the payment terms; and
generating the invoice including the selected payment terms.

14. The non-transitory computer-readable medium of claim 8, wherein the one or more instructions that, when executed by the one or more processors of the device, cause the device to perform operations comprising:
generating a customer ranking based in part on a length of relationship and a volume of transactions; and
determining a recommended payment term based in least in part on the customer ranking.

15. A system comprising:
one or more processors configured to:
access stored payment data;
for each payment term of a plurality of payment terms in the stored payment data, calculate a distribution of payment dates before, on, and after a due date;
determine an effectiveness of each of a plurality of payment terms based in part on the distribution of payment dates, wherein effectiveness is defined as a time difference between a payment due date and a payment date;
determine a recommended payment term based at least in part on the effectiveness of each of the plurality of payment terms and an objective; and
generate an invoice including the recommended payment term.

16. The system of claim 15, wherein the objective is to minimize a days sales outstanding value.

17. The system of claim 15, wherein the objective is to maximize revenue.

18. The system of claim 15, wherein the stored payment data includes customer country information, and the one or more processors are further configured to:
compare the effectiveness of each of the plurality of payment terms for each of a plurality of countries for various countries; and
wherein the determining the recommended payment term is further based in part on the comparing the effectiveness of each of the plurality of payment terms for each of the plurality of countries for various countries.

19. The system of claim 15, wherein the stored payment data includes customer segment data, and the one or more processors are further configured to:
compare the effectiveness of each of the plurality of payment terms for each of a plurality of customer segments; and
determine the recommended payment term is further based in part on the comparing the effectiveness of each of the plurality of payment terms for each of a plurality of customer segments.

20. The system of claim 15, wherein the one or more processors are further configured to:
determine a plurality of payment terms;
display the plurality of payment terms;
receive a selection of one of the plurality of the payment terms; and
generate the invoice including the selected payment terms.
